(19) United States
(12) Patent Application Publication
(10) Pub. No.: US 2026/0175794 A1
(43) Pub. Date: Jun. 25, 2026

(54) DECORATIVE SURFACE MATERIAL, DECORATIVE MEMBER, DISPLAY SYSTEM, DECORATIVE SURFACE MATERIAL PRODUCTION METHOD, AND DECORATIVE MEMBER PRODUCTION METHOD

(71) Applicant: Dai Nippon Printing Co., Ltd., Tokyo (JP)

(72) Inventor: Hiroyuki Atake, Tokyo (JP)

(73) Assignee: Dai Nippon Printing Co., Ltd., Tokyo (JP)

(21) Appl. No.: 19/128,305

(22) PCT Filed: Nov. 9, 2023
(86) PCT No.: PCT/JP2023/040468

§ 371 Date: May 8, 2025

(30) Foreign Application Priority Data
Nov. 9, 2022 (JP) 2022-179854

(51) Int. Cl. B32B 5/02; B29C 45/14; B29C 45/27; B32B 7/12; B32B 27/32

(52) U.S. Cl. CPC B60R 13/02; B29C 45/14262; B29C 45/14467; B29C 45/14688; B29C 45/14811; B29C 45/2708; B32B 5/022; B32B 7/12; B32B 27/32; B60Q 3/57; B32B 2307/416; B60K 2360/28

(57) ABSTRACT

A decorative surface material has a first surface and a second surface opposite from the first surface. The decorative surface material includes a design layer and a light shielding layer in sequence from the first surface toward the second surface. The decorative surface material includes a recessed portion that opens to the second surface. The recessed portion extends through the light shielding layer but does not extend through the design layer.

### TECHNICAL FIELD

The present disclosure relates to a decorative surface material, a decorative member, a display system, a decorative surface material production method, and a decorative member production method.

### BACKGROUND ART

As disclosed in JP 2017-65168 A, there is a known decorative surface material that includes a decorative part including a design layer and a non-decorative part not including a design layer. In JP 2017-65168 A, the design layer is removed in the non-decorative part. In JP 2017-65168 A, the decorative surface material is illuminated from the rear surface by light from a light source. As the light that has passed through the decorative surface material passes through the non-decorative part, a light emission pattern having the same shape as the shape of the non-decorative part can be observed.

According to the decorative surface material disclosed in JP 2017-65168 A, the non-decorative part is observed even when the light source is not emitting light. Since the non-decorative part is observed, the design properties of the decorative surface material disclosed in JP 2017-65168 A are degraded.

### SUMMARY OF INVENTION

An object of the present disclosure is to improve the design properties of a decorative surface material.

A decorative surface material according to one embodiment of the present disclosure is
a decorative surface material having a first surface and a second surface opposite from the first surface, the decorative surface material including:
in sequence from the first surface toward the second surface, a design layer and a light shielding layer,
in which the decorative surface material has a recessed portion that opens to the second surface, and
the recessed portion extends through the light shielding layer but does not extend through the design layer.

A display system according to one embodiment of the present disclosure includes:
a decorative member; and
a light source facing the decorative member,
in which the decorative member includes a decorative surface material having a first surface and a second surface opposite from the first surface and a thermoplastic resin part bonded to the second surface of the decorative surface material,
the thermoplastic resin part is located between the light source and the decorative surface material,
the decorative surface material includes a light shielding layer, and
the decorative surface material includes a recessed portion that opens to the second surface and extends through the light shielding layer.

A decorative member production method according to one embodiment of the present disclosure includes:
a step of molding a decorative sheet that includes a light shielding layer;
a step of preparing a decorative surface material having a recessed portion from the decorative sheet by removing a portion of the light shielding layer from the decorative sheet; and
a step of forming a thermoplastic resin part bonded to the decorative surface material.

According to the present disclosure, the design properties of the decorative surface material can be improved.

### BRIEF DESCRIPTION OF DRAWINGS

FIG. 1 is a diagram illustrating one embodiment and is a perspective view schematically illustrating an example of a display system.

FIG. 2 is a plan view illustrating the display system in FIG. 1 from the front and illustrates a state in which a light source is off.

FIG. 3 is a plan view illustrating the display system in FIG. 1 from the front and illustrates a state in which a light source is on.

FIG. 4 is a partial cross-sectional view illustrating the display system in FIG. 1.

FIG. 5 is a diagram illustrating one example of a method for producing a decorative surface material illustrated in FIG. 4.

FIG. 6 is a diagram illustrating one example of a method for producing a decorative surface material illustrated in FIG. 4.

FIG. 7 is a diagram illustrating one example of a method for producing a decorative surface material illustrated in FIG. 4.

FIG. 8 is a diagram illustrating one example of a method for producing a decorative surface material illustrated in FIG. 4.

FIG. 9 is a diagram illustrating one example of a method for producing a decorative surface material illustrated in FIG. 4.

FIG. 10 is a diagram illustrating one example of a method for producing a decorative surface material illustrated in FIG. 4.

FIG. 11 is a diagram illustrating one example of a method for producing a decorative surface material illustrated in FIG. 4.

FIG. 12 is a diagram illustrating one example of a method for producing a decorative member illustrated in FIG. 4.

FIG. 13 is a diagram illustrating one example of a method for producing a decorative member illustrated in FIG. 4.

FIG. 14 is a diagram illustrating one example of a method for producing a decorative member illustrated in FIG. 4.

FIG. 15 is a diagram illustrating one example of a method for producing a decorative member illustrated in FIG. 4.

FIG. 16 is a partial cross-sectional view illustrating a cross section equivalent to that in FIG. 4 and illustrates a modification of the display system.

FIG. 17 is a diagram illustrating one example of a method for producing a decorative surface material illustrated in FIG. 16.

FIG. 18 is a diagram illustrating one example of a method for producing a decorative surface material illustrated in FIG. 16.

FIG. 19 is a diagram illustrating one example of a method for producing a decorative surface material illustrated in FIG. 16.

FIG. 20 is a diagram illustrating one example of a method for producing a decorative member illustrated in FIG. 16.

FIG. 21 is a diagram illustrating one example of a method for producing a decorative member illustrated in FIG. 16.

FIG. 22 is a diagram illustrating one example of a method for producing a decorative member illustrated in FIG. 16.

FIG. 23 is a diagram illustrating one example of a method for producing a decorative member illustrated in FIG. 16.

FIG. 24 is a partial cross-sectional view illustrating a cross section equivalent to that in FIG. 4 and illustrates another modification of the display system.

FIG. 25 is a diagram illustrating one example of a method for producing a decorative surface material illustrated in FIG. 24.

FIG. 26 is a partial cross-sectional view illustrating a cross section equivalent to that in FIG. 4 and illustrates a yet another modification of the display system.

### DESCRIPTION OF EMBODIMENTS

One embodiment of the present disclosure relates to [1] to [19] below.

[1] A decorative surface material having a first surface and a second surface opposite from the first surface, the decorative surface material including:
in sequence from the first surface toward the second surface, a design layer and a light shielding layer,
in which the decorative surface material has a recessed portion that opens to the second surface, and
the recessed portion extends through the light shielding layer but does not extend through the design layer.

[2] The decorative surface material of [1], in which the recessed portion includes a bottom portion and a wall portion that connects the bottom portion and the second surface, and
the wall portion is not formed by the design layer.

[3] The decorative surface material of [1] or [2], in which the recessed portion is not formed in the design layer.

[4] The decorative surface material of any one of [1] to [3], in which the recessed portion is formed by a portion where the light shielding layer has been removed by using laser irradiation from the second surface side.

[5] The decorative surface material of any one of [1] to [4], further including a base layer disposed between the design layer and the light shielding layer,
in which the bottom portion of the recessed portion is formed by the base layer.

[6] The decorative surface material of any one of [1] to [5], wherein the first surface has an uneven shape.

[7] A decorative member including:
the decorative surface material of any one of [1] to [6]; and
a thermoplastic resin part bonded to the second surface of the decorative surface material.

[8] a display system including:
a light source; and
the decorative member of [7] overlaying the light source,
in which the thermoplastic resin part is located between the light source and the decorative surface material.

[9] A decorative surface material production method including:
a step of removing, from a decorative sheet that includes a design layer and a light shielding layer in sequence from a first surface toward a second surface, a portion of the light shielding layer from the second surface side to form a recessed portion,
in which the recessed portion extends through the light shielding layer but does not extend through the design layer.

[10] The decorative surface material production method of [9], in which the recessed portion includes a bottom portion and a wall portion that connects the bottom portion and the second surface, and
the wall portion is not formed by the design layer.

[11] The decorative surface material production method of [9] or [10], in which the recessed portion is not formed in the design layer.

[12] The decorative surface material production method of any one of [9] to [11], in which the recessed portion is formed in the decorative sheet that has been subjected to a molding process.

[13] A decorative member production method including, in sequence:
a step of molding a decorative sheet that includes a design layer and a light shielding layer in sequence from a first surface toward a second surface;
a step of preparing a decorative surface material having a recessed portion from the decorative sheet by removing a portion of the light shielding layer from the second surface side of the decorative sheet; and
a step of forming a thermoplastic resin part bonded to the decorative surface material,
in which the recessed portion extends through the light shielding layer but does not extend through the design layer.

[14] The decorative member production method of [13], in which the recessed portion includes a bottom portion and a wall portion that connects the bottom portion and the second surface, and the wall portion is not formed by the design layer.

[15] The decorative member production method of [13] or [14], wherein the recessed portion is not formed in the design layer.

[16] The decorative member production method of any one of [13] to [15], in which the portion of the light shielding layer is removed by laser irradiation from the second surface side.

[17] The decorative member production method of any one of [13] to [16], in which the thermoplastic resin part bonded to the decorative surface material is formed by conveying the decorative surface material into a mold that includes a first mold and a second mold and, while the decorative surface material is housed in the mold, injecting a thermoplastic resin into a cavity formed between the first mold and the second mold.

[18] The decorative member production method of any one of [13] to [17], in which
the decorative sheet is molded by using a first mold,
the decorative surface material is prepared by forming a recessed portion in the decorative sheet placed on the first mold, and
the thermoplastic resin part bonded to the decorative surface material is formed by, while the decorative surface material is placed on the first mold, stacking the second mold on the first mold and injecting a thermoplastic resin into a cavity formed between the first mold and the second mold.

[19] The decorative member production method of [17] or [18], in which the first mold has an uneven shape in a portion that faces the decorative surface material placed on the first mold, and
the decorative surface material is pressed against the uneven shape of the first mold by the thermoplastic resin injected from the cavity.

An embodiment of the present disclosure will now be described with reference to the drawings. In the drawings attached to the present description, for the convenience of illustration and ease of understanding, the scale, the dimensional ratios in horizontal and vertical directions, etc., are altered and exaggerated as appropriate from the actual features.

Terms such as “plate”, “sheet”, and “film” are not to be distinguished from one another solely on the basis of the difference in addressed terms. For example, a “plate” is a concept that includes a member that can be referred to as sheet or film, and thus a “light diffusing plate” is not distinguishable from a member referred to as “light diffusing sheet” or “light diffusing film” solely on the basis of the difference in addressed terms.

The terms, such as “parallel”, “orthogonal”, and “identical”, that specify the shape, geometrical conditions, and extents thereof, values such as lengths and angles, etc., are not limited to strict definitions, and are interpreted as inclusive of ranges in which similar functions can be expected.

In the present disclosure, terms such as “sheet”, “film”, and “plate” are not to be distinguished from one another solely on the basis of the difference in addressed terms. For example, a “decorative sheet” is not distinguishable from a member that is referred to as a decorative film or a decorative plate solely on the basis of the difference in addressed term.

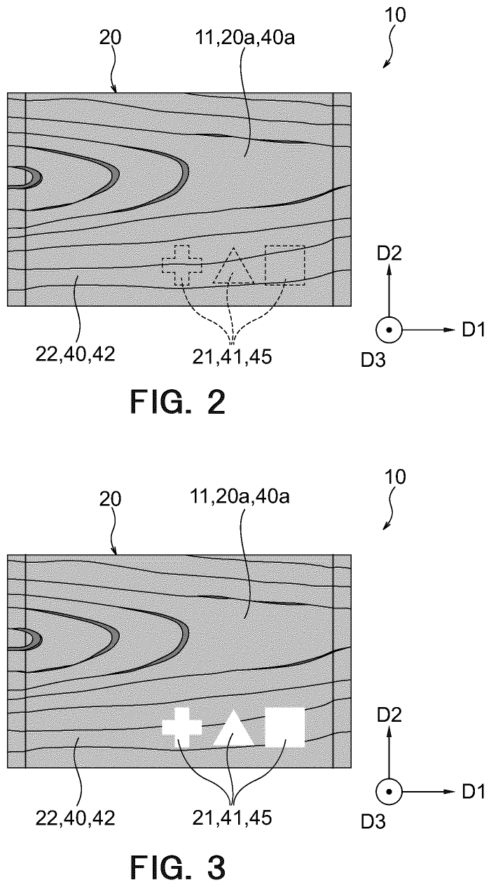

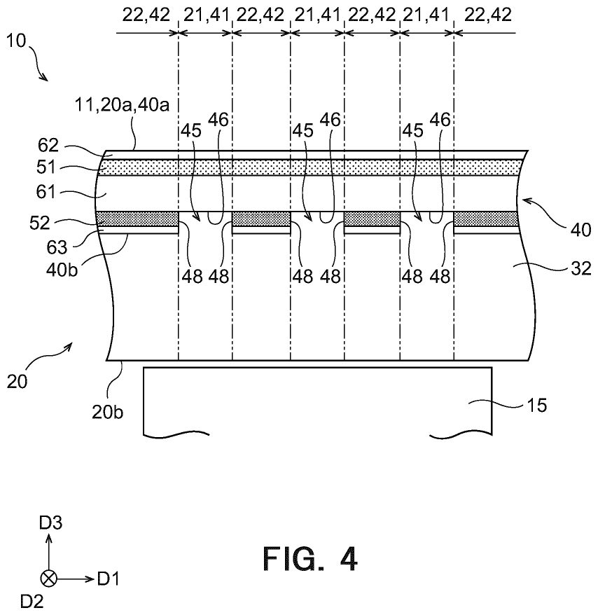

In order to clarify the directional relationships among the drawings, some drawings show arrows that are denoted by common reference signs to indicate directions common to the drawings. A head side of an arrow is a first side of each direction. An arrow that extends out of the page in a direction perpendicular to the page is indicated by a circle sign with a dot inside as illustrated in, for example, FIG. 2. An arrow that extends into the page in a direction perpendicular to the page is indicated by a circle sign with X inside as illustrated in, for example, FIG. 4.

In the present disclosure, when there are multiple candidates for the upper limit value and the lower limit value regarding a particular parameter, the numerical range of this parameter may be a combination of any one of the candidates for the upper limit value and any one of the candidates for the lower limit value. As one example, the following phrase is examined: “A parameter B may be A1 or more, A2 or more, or A3 or more. The parameter B may be A4 or less, A5 or less, or A6 or less.” In this example, the numerical range of the parameter B may be A1 or more and A4 or less, A1 or more and A5 or less, A1 or more and A6 or less, A2 or more and A4 or less, A2 or more and A5 or less, A2 or more and A6 or less, A3 or more and A4 or less, A3 or more and A5 or less, or A3 or more and A6 or less.

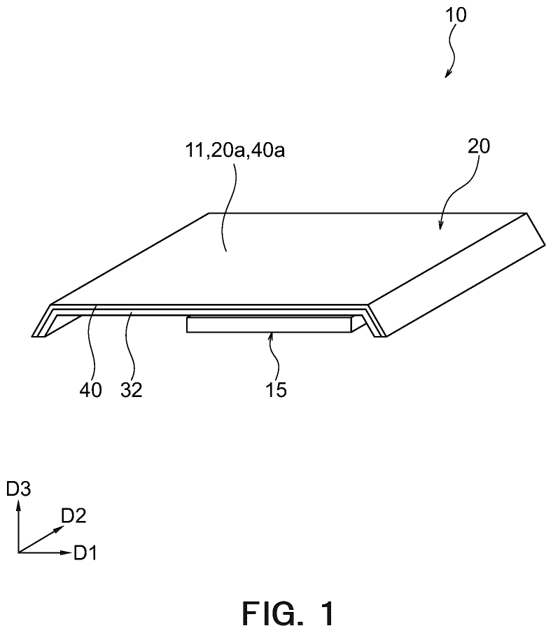

FIGS. 1 to 15 are drawings that illustrate one embodiment. FIG. 1 is a perspective view schematically illustrating a specific example of a display system. As illustrated in FIG. 1, a display system 10 includes a light source 15 and a decorative member 20 overlaying the light source 15. The display system 10 can be observed from a display surface 11. The display surface 11 may display a design. The display surface 11 may display an image. The image may be formed by the light of the light source 15 emitted from the display surface 11.

The display system 10 can be applied to various usages. The display system 10 may be applied to interiors and exteriors of moving bodies as moving apparatuses. Examples of the moving bodies include automobiles, ships, and airplanes. As one specific example, the display system 10 may be applied to an interior or exterior of an automobile. The display system 10 may be applied to a wall, a door, a ceiling, and the like, as interiors of a building. The display system may be applied to various apparatuses such as furniture and home electric appliances.

The light source 15 is capable of emitting light. The light source 15 can assume a state in which light is being emitted (on state) and a state in which light emission is stopped (off state). The light source 15 may include a cold cathode tube as a luminant. The light source 15 may include a light-emitting diode (LED) as a luminant. The light source 15 may further include an optical member that can adjust the direction of light from the luminant. The light source 15 may be an area light source apparatus that emits area light.

In the example illustrated in FIGS. 1 and 4, the light source 15 is covered with a decorative member 20 and a decorative surface material 40. The decorative surface material is a sheet obtained by removing some portions from a decorative sheet. The light source 15 includes a portion that faces recessed portions 45 of the decorative surface material 40 described below. The light source 15 is hidden by the decorative surface material 40 from the observer observing the decorative surface material 40.

In the example illustrated in FIGS. 1 to 3, the decorative member 20 spreads into a sheet shape from a broad perspective. The decorative member 20 spreads in a first direction D1 and a second direction D2 orthogonal to the first direction D1. The decorative member 20 includes a decorative surface material 40 and a thermoplastic resin part 32 that overlays the decorative surface material 40 in a third direction D3. The thermoplastic resin part 32 is bonded to the decorative surface material 40. The thermoplastic resin part 32 is located between the light source 15 and the decorative surface material 40 in the third direction D3.

In the example illustrated in FIGS. 1 to 4, the decorative member 20 has a first surface 20a and a second surface 20b opposite from the first surface 20a. The first surface 20a constitutes the display surface 11 of the display system 10. The observer of the display system 10 observes the display surface 11. The decorative member 20 can be observed from the first surface 20a. The second surface 20b of the decorative member 20 faces the light source 15.

The decorative member 20 displays a design presented by the decorative surface material 40. The design displayed by the decorative member 20 is also displayed as a design in the display system 10. With the decorative member 20 illustrated in FIGS. 2 and 3, a wood-grain design can be observed as the design presented by the decorative surface material 40.

In the example illustrated in FIGS. 1 to 3, the decorative member 20 has a transmitting part 21 and a light shielding part 22. The transmitting part 21 has visible light transmitting properties. The light shielding part 22 has visible light shielding properties. In the display system 10, the light emitted from the light source 15 toward the decorative member 20 can pass through the transmitting part 21. The light emitted from the light source 15 toward the decorative member 20 can be absorbed by the light shielding part 22. With this decorative member 20, the difference in transmittance between the transmitting part 21 and the light shielding part 22 makes the transmitting part 21 distinguishable from the light shielding part 22. It becomes possible for the observer to observe the transmitting part 21 as a display pattern. The transmitting part 21 is to have such visible light transmitting properties that can transmit visible light to an extent sufficient for the transmitting part 21 to be distinguishable from the light shielding part 22. The transmitting part 21 does not have to have such visible light transmitting properties that can transmit visible light to an extent sufficient for the transmitting part 21 to be referred to as transparent. The transmitting part 21 may be smoke colored. The light shielding part 22 is to have such visible light shielding properties that can shield visible light to an extent sufficient for the light shielding part 22 to be distinguishable from the transmitting part 21.

“Visible light transmitting properties” mean that the visible light transmittance is 3% or more. “Transparent” means that the visible light transmittance is 50% or more and preferably 80% or more. “Visible light shielding properties” mean that the visible light transmittance is 1% or less and preferably 0.2% or less. The visible light transmittance is specified as an average value of the transmittance at each wavelength measured in 1 nm increments in a measurement wavelength range of 380 nm to 780 nm at an incident angle of 0°. The transmittance at each wavelength is measured by using a haze meter (product of MURAKAMI COLOR RESEARCH LABORATORY CO., LTD., product no.: HM-150) in accordance with JIS K 7361.

The display system 10 illustrated in FIG. 3 can display the pattern of the transmitting part 21 as an image due to the difference between the visible light transmittance of the transmitting part 21 and the visible light transmittance of the light shielding part 22. In the illustrated example, a cross, a triangle, and a square are displayed.

The decorative member 20 may have a three-dimensional shape. In the example illustrated in FIG. 1, two end portions of the decorative member 20 in the first direction D1 are bent toward the third direction D3. The bent portions of the decorative member 20 extend in the second direction D2.

In the example illustrated in FIG. 4, the decorative surface material 40 has a first surface 40a and a second surface 40b opposite from the first surface 40a. The first surface 40a constitutes the first surface 20a of the decorative member 20. Thus, the first surface 40a of the decorative surface material 40 constitutes the display surface 11 of the display system 10. In the illustrated example, the first surface 40a is flat. The second surface 40b of the decorative surface material 40 is bonded to the thermoplastic resin part 32.

The decorative surface material 40 includes a design layer 51 and a light shielding layer 52 from the first surface 40a toward the second surface 40b. In the example illustrated in FIG. 4, the design layer 51 and the light shielding layer 52 are stacked in the third direction D3. In other words, in the illustrated decorative surface material 40, the third direction D3 is the stacking direction.

The decorative surface material 40 may include layers other than the design layer 51 and the light shielding layer 52. In the example illustrated in FIG. 4, the decorative surface material 40 includes, in sequence from the first surface 40a toward the second surface 40b, a surface layer 62, a design layer 51, a base layer 61, a light shielding layer 52, and a bonding layer 63.

In the example illustrated in FIGS. 2 to 4, the decorative surface material 40 has a transmitting part 41 and a light shielding part 42. In the example illustrated in FIG. 4, the transmitting part 41 and the light shielding part 42 are adjacent to each other in the first direction D1. The transmitting part 41 has visible light transmitting properties. The light shielding part 42 has visible light shielding properties. In the illustrated decorative surface material 40, the light shielding part 42 is located on a portion that includes the light shielding layer 52. The transmitting part 41 is located on a portion that does not include the light shielding layer 52.

In the illustrated display system 10, the transmitting part 41 is capable of transmitting light emitted from the light source 15. The light shielding part 42 is capable of absorbing light emitted from the light source 15. In the decorative member 20 including the decorative surface material 40, the transmitting part 21 may be formed by the transmitting part 41 of the decorative surface material 40.

The light shielding part 22 may be formed by the light shielding part 42 of the decorative surface material 40.

In the example illustrated in FIG. 4, the decorative surface material 40 has recessed portions 45 that open to the second surface 40b. The recessed portions 45 do not open to the first surface 40a. In other words, the recessed portions 45 do not extend through the decorative surface material 40 in the stacking direction. In the recessed portions 45, the decorative surface material 40 is recessed in the third direction D3 which is the stacking direction.

In the decorative surface material 40 illustrated in FIG. 4, three recessed portions 45 lined up in the first direction D1 are provided. A thermoplastic resin part 32 bonded to the decorative surface material 40 is in the recessed portions 45. In the recessed portions 45, the decorative surface material 40 can transmit light emitted from the light source 15.

The recessed portions 45 extend through the light shielding layer 52. Since the recessed portions 45 extend through the light shielding layer 52, the decorative surface material 40 can gain the visible light transmitting properties in the recessed portions 45. Thus, the recessed portions 45 can form the transmitting part 41 of the decorative surface material 40. As illustrated in FIG. 4, the recessed portions 45 may extend through the layers other than the light shielding layer 52 of the decorative surface material 40. In the illustrated example, the recessed portions 45 also extend through the bonding layer 63. The recessed portions 45 are formed by portions that extend through the light shielding layer 52 and portions that extend through the bonding layer 63. The recessed portions 45 may be formed by removing some portions of the light shielding layer 52 from the second surface 40b side of the decorative surface material 40. The light shielding layer 52 may be removed by laser irradiation from the second surface 40b side of the decorative surface material 40.

The recessed portions 45 do not extend through the design layer 51. As illustrated in the decorative surface material of FIG. 4, the recessed portions 45 do not have to extend layers other than the design layer 51 of the decorative surface material 40. In the illustrated example, the recessed portions 45 do not extend through the base layer 61. Unlike the example illustrated in the drawing, in the decorative surface material 40, recessed portions 45 may be formed in some portions of the base layer 61. Unlike the example illustrated in the drawing, in the decorative surface material 40, recessed portions 45 may extend through the base layer 61.

As mentioned above, the recessed portions 45 extend through the light shielding layer 52 but do not extend through the design layer 51. In other words, the recessed portions 45 extend through only the light shielding layer 52 among the light shielding layer 52 and the design layer 51. Of the light shielding layer 52 and the design layer 51, only the light shielding layer 52 is extended through by the recessed portions 45.

The recessed portions 45 illustrated in FIG. 4 each include a bottom portion 46 and a wall portion 48 that connects the bottom portion 46 and the second surface 40b. In the illustrated decorative surface material 40, the bottom portion 46 is located on the first surface 40a side with respect to the wall portion 48. The “bottom portion” means a portion where the angle relative to the stacking direction in the recessed portion is 45° or more and 90° or less. The illustrated bottom portion 46 is oriented in the third direction D3. In other words, the angle of the illustrated bottom portion 46 relative to the stacking direction is 90°. The “wall portion” means a portion where the angle relative to the stacking direction in the recessed portion is 0° or more and less than 45°. The illustrated wall portion 48 extends in the third direction D3 between the bottom portion 46 and the second surface 40b. In other words, the angle of the illustrated wall portion 48 relative to the stacking direction is 0°.

In the decorative surface material 40 illustrated in FIG. 4, the bottom portion 46 is formed by the base layer 61. In the illustrated decorative surface material 40, the wall portion 48 is formed by the light shielding layer 52 and the bonding layer 63. In the illustrated decorative surface material 40, the recessed portions 45 are not formed in the design layer 51. In the illustrated recessed portions 45, none of the bottom portions 46 and the wall portions 48 are formed by the design layer 51.

Hereinafter, constitutional elements of the decorative surface material 40 are described by mainly referring to FIG. 4.

In the example illustrated in FIG. 4, the surface layer 62 forms the first surface 40a of the decorative surface material 40. The surface layer 62 may form an observer-side surface of the decorative member 20. The surface layer 62 may be transparent. The surface layer 62 may be colored. In one specific example of the illustrated decorative surface material 40, it is possible to observe the design layer 51 through the transparent surface layer 62. The surface layer 62 may exhibit various functions. The surface layer may be a hard coat layer that exhibits scuff resistance. The surface layer may be an antifouling layer that exhibits an antifouling function. The surface layer may be an antiglare layer that exhibits an antiglare function. The surface layer may be an antireflection layer that exhibits an antireflection function.

The surface layer 62 may include a thermoplastic resin. The surface layer 62 may include a cured product of a curable resin composition. The curable resin composition may include at least one of an ionizing radiation-curable resin and a thermosetting resin. The ionizing radiation-curable resin may include a UV-curable resin and an electron beam radiation resin. The thickness of the surface layer 62 is not particularly limited. The thickness of the surface layer 62 (in FIG. 4, the length in the third direction D3) may be 1 μm or more or 5 μm or more. The thickness of the surface layer 62 may be 1000 μm or less, 500 μm or less, 100 μm or less, or 30 μm or less. The surface layer 62 may be omitted from the decorative surface material 40.

In the example illustrated in FIG. 4, the design layer 51 is located between the surface layer 62 and the base layer 61 in the third direction D3. The design layer 51 straddles over the transmitting part 41 and the light shielding part 42 of the decorative surface material 40. In other words, the design layer 51 is located so as to face both the transmitting part 41 and the light shielding part 42 of the decorative surface material 40. The design layer 51 forms a design to be displayed by the decorative surface material 40.

The design layer 51 can transmit light emitted from the light source 15. In the example illustrated in FIG. 4, in portions overlaying the recessed portions 45, the design layer 51 can transmit light emitted from the light source 15. In this manner, as illustrated in FIG. 3, the light that has passed through the design layer 51 and the surface layer 62 in portions overlaying the recessed portions 45 can be displayed as display light.

The design layer 51 may have visible light transmitting properties. The visible light transmittance of the design layer 51 may be 10% or more or 20% or more. The visible light transmittance of the design layer 51 may be 50% or less or 40% or less.

The design to be displayed by the design layer 51 may include at least one representation such as a graphic, a pattern, a design, a color, a picture, a photograph, a character, a mark, a pictogram, an alphabet, and a numerical figure. The design layer 51 can present a design that displays a background. For example, as a design that can be in harmony with the ambient environment in which the display system 10 is installed, a wood-grain or marble-like representation or a geometric pattern may be displayed by the design layer 51. In the example illustrated in FIGS. 2 and 3, the design layer 51 creates a wood-grain-like representation.

The design layer 51 may include a binder resin portion and a color material retained by the binder resin portion. The binder resin portion may include a thermoplastic resin. The binder resin portion may include a cured product of a curable resin composition. The curable resin composition may include at least one of an ionizing radiation-curable resin and a thermosetting resin. The ionizing radiation-curable resin may include a UV-curable resin and an electron beam radiation resin. The color material may be a dye, a pigment, or a combination of a dye and a pigment.

The design layer 51 may be formed by printing. The design layer 51 may be formed by transfer. The thickness of the design layer 51 may be 1 μm or more and 30 μm or less.

In the example illustrated in FIG. 4, the base layer 61 is located between the design layer 51 and the light shielding layer 52 in the third direction D3. The base layer 61 can transmit the light emitted from the light source 15. The base layer 61 may have visible light transmitting properties. The visible light transmittance of the base layer 61 may be 30% or more or 40% or more. The base layer 61 may be transparent. The illustrated base layer 61 has a transparent film shape. A film may be used as the base layer 61. The base layer 61 may be formed by coating. The base layer 61 may be a coating layer. When the base layer 61 is a coating layer, a film may be used as the surface layer 62. The base layer 61 may support the design layer 51. The base layer 61 may support the light shielding layer 52. The base layer 61 may support layers other than the base layer 61 of the decorative surface material 40.

The base layer 61 may include a resin. The base layer 61 may include a thermoplastic resin. The base layer 61 may be a film made of a thermoplastic resin. The thermoplastic resin may include at least one of acrylic, PET (polyethylene terephthalate), a polyolefin-based resin such as polypropylene or polyethylene, polycarbonate, and ABS (acrylonitrile-butadiene-styrene copolymer synthetic resin). The base layer 61 may be colored. The base layer 61 may form a design displayed by the decorative surface material 40.

The thickness of the base layer 61 may be 1 μm or more or 5 μm or more. By setting the lower limit to the thickness of the base layer 61, as described in detail below, the recessed portions 45 formed by laser etching from the second surface 40b side can be inhibited from extending through the design layer 51. The thickness of the base layer 61 may be 500 μm or less or 300 μm or less. By setting the upper limit to the thickness of the base layer 61, the molding processability of the decorative surface material 40 can be improved.

In the example illustrated in FIG. 4, the light shielding layer 52 is located between the base layer 61 and the bonding layer 63 in the third direction D3. The light shielding layer 52 has visible light shielding properties. Since the light shielding layer 52 has visible light shielding properties, the light from the light source 15 can be absorbed by the light shielding layer 52. Thus, the light from the light source 15 is inhibited from entering portions of the design layer 51 overlaying the light shielding layer 52. That is, in the illustrated example, the light shielding layer 52 forms the light shielding part 42 of the decorative surface material 40.

The light shielding layer 52 may include a color material and a base material that retains the color material. The color material may be a pigment such as carbon black or titanium black. The base material may include a thermoplastic resin. The base material may include a cured product of a curable resin composition.

The light shielding layer 52 may be formed by printing. The light shielding layer 52 may be formed by transfer. The thickness of the light shielding layer 52 may be 1 μm or more or 3 μm or more. By setting the lower limit to the thickness of the light shielding layer 52, the light shielding layer 52 can securely obtain sufficient visible light shielding properties. The thickness of the light shielding layer 52 may be 100 μm or less or 20 μm or less.

In the example illustrated in FIG. 4, the bonding layer 63 constitutes the second surface 40b of the decorative surface material 40. The bonding layer 63 may be provided for the purpose of improving the adhesion between the decorative surface material 40 and the thermoplastic resin part 32. The bonding layer 63 may contain an adhesive material or a pressure-sensitive adhesive material. The adhesive material contained in the bonding layer 63 may contain at least one selected from an acrylic adhesive material, a rubber-based adhesive material, a urethane-based adhesive material, and a silicone-based adhesive material. The pressure-sensitive adhesive material contained in the bonding layer 63 may contain at least one selected from an acrylic pressure-sensitive adhesive material, a rubber-based pressure-sensitive adhesive material, a urethane-based pressure-sensitive adhesive material, and a silicone-based pressure-sensitive adhesive material.

From the viewpoint of ensuring the adhesion between the decorative surface material 40 and the thermoplastic resin part 32, the thickness of the adhesive layer 63 may be 1 μm or more or 3 μm or more. The thickness of the bonding layer 63 may be 30 μm or less or 20 μm or less. By setting the upper limit to the thickness of the adhesive layer 63, recessed portions 45 can be formed by easily removing some portions of the light shielding layer 52 located on the first surface 40a side with respect to the adhesive layer 63. The bonding layer 63 may be omitted from the decorative surface material 40.

In the example illustrated in FIG. 4, the thermoplastic resin part 32 is bonded to the decorative surface material 40. The thermoplastic resin part 32 is bonded to the second surface 40b of the decorative surface material 40. The thermoplastic resin part 32 also fills inside the recessed portions 45 of the decorative surface material 40. The thermoplastic resin part 32 is located between the decorative surface material 40 and the light source 15 in the third direction D3. The thermoplastic resin part 32 and the decorative surface material 40 are stacked on top of each other in the third direction D3. As illustrated in FIG. 4, a space may be formed between the thermoplastic resin part 32 and the light source 15.

In the example illustrated in FIG. 4, the thermoplastic resin part 32 includes a base portion 32a and protruding portions 32b protruding from the base portion 32a toward the decorative surface material 40. In the base portion 32a, the thermoplastic resin part 32 bonds to the bonding layer 63. In the protruding portions 32b, the thermoplastic resin part 32 bonds to the design layer 51, the base layer 61, and the light shielding layer 52. In the protruding portions 32b, the thermoplastic resin part 32 is located on the recessed portions 45 of the decorative surface material 40.

In the illustrated example, the thermoplastic resin part 32 is transparent. The light emitted from the light source 15 can pass through the thermoplastic resin part 32. The thermoplastic resin part 32 may be colored. The thermoplastic resin part 32 may form a design to be displayed by the decorative member 20.

The thermoplastic resin part 32 may be prepared by melt-bonding the injection resin 33 to the decorative surface material 40. As described in detail below, the thermoplastic resin part 32 may be formed by injecting the injection resin 33 into a cavity 130 formed in an injection molding apparatus 90.

The thickness of the thermoplastic resin part 32 is not particularly limited. From the viewpoint of stably retaining the shape of the decorative member 20, the thickness of the thermoplastic resin part 32 (in FIG. 4, the length in the third direction D3) may be 0.5 mm or more or 1 mm or more. From the viewpoint of imparting a high visible light transmittance to the thermoplastic resin part 32, the thickness of the thermoplastic resin part 32 may be 10 mm or less or 5 mm or less. The thickness of the thermoplastic resin part 32 may be larger than the thickness of the decorative surface material 40.

One example of the method for producing the decorative member 20 illustrated in FIG. 4 will now be described. In preparing the illustrated decorative member 20, first, a decorative sheet 35 is prepared. A decorative surface material 40 is prepared by subjecting the prepared decorative sheet 35 to a molding process and laser etching. A decorative member 20 is prepared by bonding the thermoplastic resin part 32 to the prepared decorative surface material 40. The method for producing the illustrated decorative member 20 is described in detail below.

First, preparation of the decorative surface material 40 is explained. As explained below, in preparing the decorative surface material 40, first, a decorative sheet 35 is prepared. The decorative sheet 35 is a sheet-shaped member that has a first surface 35a and a second surface 35b opposite from the first surface 35a. The first surface 35a of the decorative sheet 35 will constitute the first surface 40a of the decorative surface material 40. The second surface 35b of the decorative sheet 35 will constitute the second surface 40b of the decorative surface material 40. Next, the decorative sheet 35 is laser-etched from the second surface 35b side to prepare a decorative surface material 40 having recessed portions 45. In the present disclosure, a decorative sheet 35 in which formation of the recessed portions 45 has been completed is referred to as a decorative surface material 40. In the present disclosure, a decorative sheet 35 in which formation of the recessed portions 45 has not been completed is not referred to as a decorative surface material 40. When the decorative surface material 40 includes multiple recessed portions 45, a decorative sheet 35 in which formation of all of the multiple recessed portions 45 has been completed is referred to as a decorative surface material 40. A decorative sheet 35 in which only some of the multiple recessed portions 45 are formed is not referred to as a decorative surface material 40.

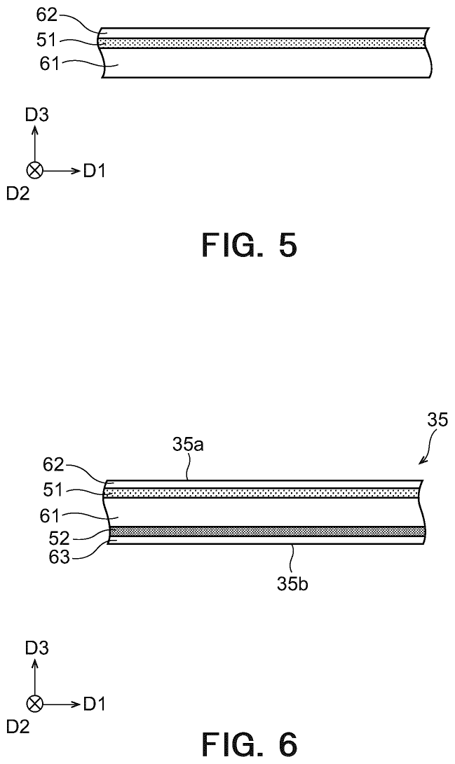

Next, preparation of the decorative sheet 35 is explained. First, a sheet that forms the base layer 61 is prepared. The material and thickness of the base layer 61 are as described above. Then a design layer 51 is formed on one surface of the base layer 61 as illustrated in FIG. 5. The method for forming the design layer 51 and the material and thickness of the design layer 51 are as described above.

Next, as illustrated in FIG. 5, a surface layer 62 is formed on the design layer 51. The surface layer 62 may be prepared by supplying a resin composition onto the design layer 51 to form a coating film of this resin composition and drying or curing the coating film. By forming the surface layer 62, as illustrated in FIG. 5, the design layer 51 comes to be located between the base layer 61 and the surface layer 62.

Next, as illustrated in FIG. 6, a light shielding layer 52 is formed on a surface of the base layer 61 opposite from the surface on which the design layer 51 and the surface layer 62 are formed. The method for forming the light shielding layer 52 and the material and thickness of the light shielding layer 52 are as described above. By forming the light shielding layer 52, as illustrated in FIG. 6, the base layer 61 comes to be located between the design layer 51 and the light shielding layer 52.

Next, as illustrated in FIG. 6, a bonding layer 63 is formed on the light shielding layer 52. The bonding layer 63 may be prepared by supplying a resin composition onto the light shielding layer 52 to form a coating film of this resin composition and drying the coating film. The material and thickness of the adhesive layer 63 are as described above.

As such, a decorative sheet 35 that includes a design layer 51 and a light shielding layer 52 in sequence from the first surface 35a toward the second surface 35b is obtained. In the example illustrated in FIG. 6, the decorative sheet 35 includes, in sequence from the first surface 35a toward the second surface 35b, a surface layer 62, a design layer 51, a base layer 61, a light shielding layer 52, and a bonding layer 63. The first surface 35a of the decorative sheet 35 is formed by the surface layer 62. The second surface 35b of the decorative sheet 35 is formed by the bonding layer 63. The method for producing the decorative sheet 35 is not limited to the example described above. For example, the order in which the surface layer 62, the design layer 51, the light shielding layer, 52 and the bonding layer 63 are prepared may be changed.

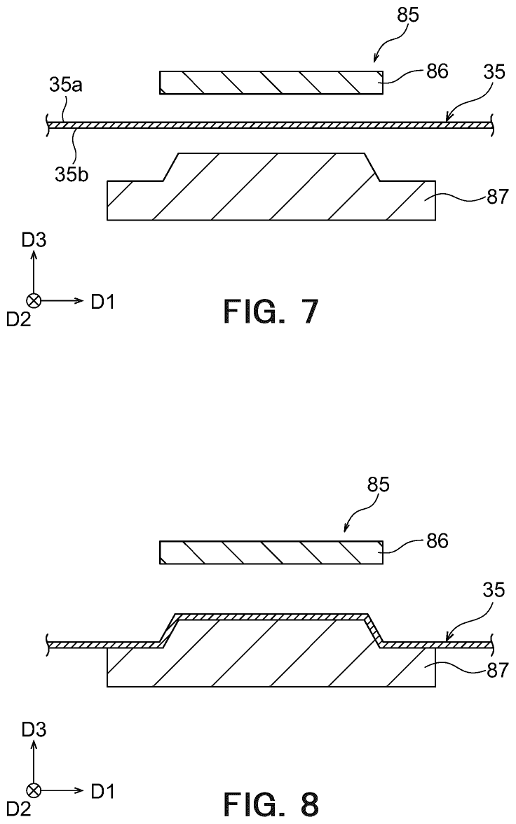

Next, as illustrated in FIGS. 7 to 9, the decorative sheet 35 is subjected to a molding process. The molding process means a process of imparting a desired shape to the decorative sheet 35. The molding process may be vacuum molding, compressed air molding, bending, or the like. The molding process may be a preliminary molding process performed before injection molding. The decorative sheet 35 undergoes plastic deformation by the molding process.

In the illustrated example, the decorative sheet 35 is vacuum-molded by using a vacuum molding apparatus 85. The vacuum molding apparatus 85 includes a heater 86 that heats the decorative sheet 35 and a vacuum mold 87 that vacuum-molds the decorative sheet 35. The decorative sheet 35 is not limited to the example illustrated in FIGS. 7 to 9, and may be plastically deformed by various molding methods such as compressed air molding and bending.

In vacuum molding of the decorative sheet 35 illustrated in FIGS. 7 to 9, first, as illustrated in FIG. 7, the decorative sheet 35 is heated with the heater 86 of the vacuum molding apparatus 85. The decorative sheet 35 softens when the decorative sheet 35 is heated. When the decorative sheet 35 is heated, the vacuum mold 87 may be disposed near the decorative sheet 35. In the illustrated example, the decorative sheet 35 is located between the heater 86 and the vacuum mold 87 in the third direction D3.

Next, as illustrated in FIG. 8, the decorative sheet 35 is suctioned. The decorative sheet 35 is vacuum-suctioned through minute holes (not illustrated) formed in the vacuum mold 87. Consequently, the decorative sheet 35 is suctioned onto the vacuum mold 87. As a result, the decorative sheet 35 is molded into a shape that conforms with the shape of the vacuum mold 87. The decorative sheet 35 comes to have a shape that follows the shape of the vacuum mold 87. In the illustrated example, the decorative sheet 35 comes to have bent portions at two end portions in the first direction D1.

Next, in a state illustrated in FIG. 8, the temperature of the decorative sheet 35 is decreased.

The decorative sheet 35 sets into a shape after molding.

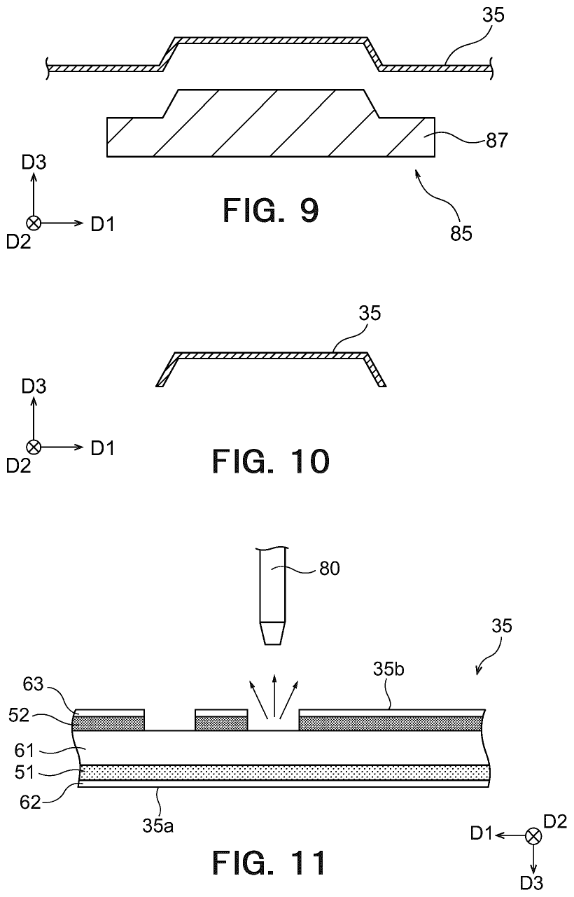

Next, as illustrated in FIG. 9, the decorative sheet 35 is removed from the vacuum mold 87. In the illustrated example, the decorative sheet 35 is separated from the vacuum mold 87 in the third direction D3.

Next, as illustrated in FIG. 10, unneeded parts are trimmed from the decorative sheet 35 removed from the vacuum mold 87. In the illustrated example, a decorative sheet 35 having bent shapes at two end portions in the first direction D1 is obtained by trimming the unneeded parts.

As such, the decorative sheet 35 is molded. Next, as illustrated in FIG. 11, some portions of the light shielding layer 52 are removed from the second surface 35b side of the decorative sheet 35. By removing some portions of the light shielding layer 52, a decorative surface material 40 having recessed portions 45 is obtained. The removed portions of the light shielding layer 52 are at designated positions of the decorative sheet 35 that has been given a shape by molding. In the example illustrated in FIG. 11, some portions of the light shielding layer 52 are removed by laser etching using the laser irradiation apparatus 80. The method for removing some portions of the light shielding layer 52 is not limited to laser etching. For example, some portions of the light shielding layer 52 may be removed by marking off the decorative sheet 35 from the second surface 35b side.

In the example illustrated in FIG. 11, the laser beam emitted from the laser irradiation apparatus 80 irradiates the decorative sheet 35 from the second surface 35b side of the decorative sheet 35. The laser beam enters the decorative sheet 35 from the second surface 35b side. The laser beam that has entered the decorative sheet 35 from the second surface 35b side removes some portions of the bonding layer 63 and some portions of the light shielding layer 52.

The laser irradiation apparatus 80 can remove the member located at a laser beam focus position. The laser beam focus position can be controlled by a controller (not illustrated) electrically connected to the laser irradiation apparatus 80. In the example illustrated in FIG. 11, the controller is capable of controlling the laser beam focus position according to the distances from the laser irradiation apparatus 80 to the bonding layer 63 and the light shielding layer 52 such that some portions of the bonding layer 63 and some portions of the light shielding layer 52 are removed.

By removing one portion of the bonding layer 63 and the light shielding layer 52, as illustrated in FIG. 11, an opening is formed in the second surface 35b of the decorative sheet 35. After laser etching, the decorative sheet 35 includes the design layer 51 in portions that overlay the removed portions of the light shielding layer 52 in the third direction D3. By irradiating the decorative sheet 35 with the laser from the second surface 35b side, it becomes possible to suppress irradiation of the design layer 51 with the laser beam. As a result, unintended removal of the design layer 51 can be suppressed.

The laser beam used in laser etching is not particularly limited. Laser beams emitted from various types of laser light sources can be used. The wavelength of the laser beam used in laser etching is also not particularly limited. The laser beam may have a wavelength in the visible light range or a wavelength in the infrared range. A laser beam for which the light shielding layer 52 has a high absorption may be used as the laser beam. The laser beam absorption of the light shielding layer 52 may be 5% or more or 10% or more. The upper limit of the laser beam absorption of the light shielding layer 52 is not particularly limited. The laser beam absorption of the light shielding layer 52 may be 100% or less or 95% or less. A laser beam for which the base layer 61 has a low absorption may be used as the laser beam.

As described above, a decorative surface material 40 having recessed portions 45 is prepared. The prepared decorative surface material 40 includes recessed portions 45 that open to the second surface 40b.

It should be noted that, unlike the illustrated example, the method for producing the decorative surface material 40 does not have to include the aforementioned step of performing a molding process on the decorative sheet 35. A decorative surface material 40 may be prepared by removing some portions of the light shielding layer 52 from the second surface 35b of a decorative sheet 35 that has not been subjected to the molding process.

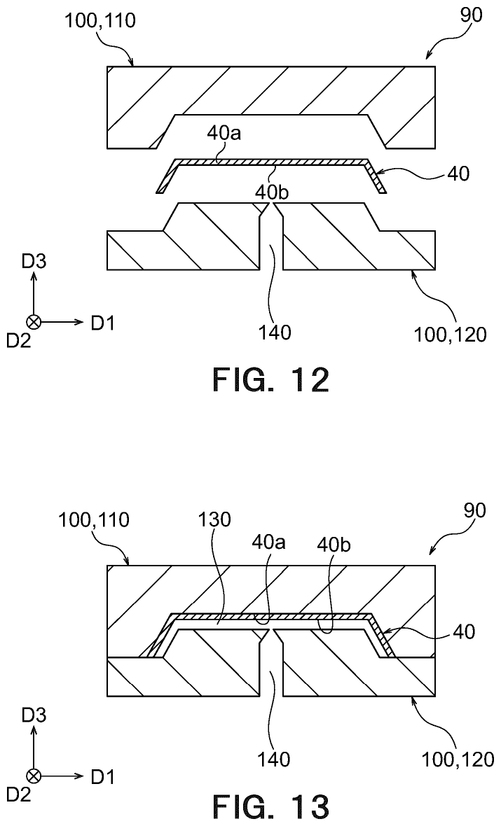

Next, a decorative member 20 is prepared by using the prepared decorative surface material 40. First, as illustrated in FIG. 12, an injection molding apparatus 90 is prepared. The injection molding apparatus 90 includes a mold 100. In the example illustrated in FIG. 12, the mold 100 includes a first mold 110 and a second mold 120. In the illustrated example, the first mold 110 and the second mold 120 face each other in the third direction D3.

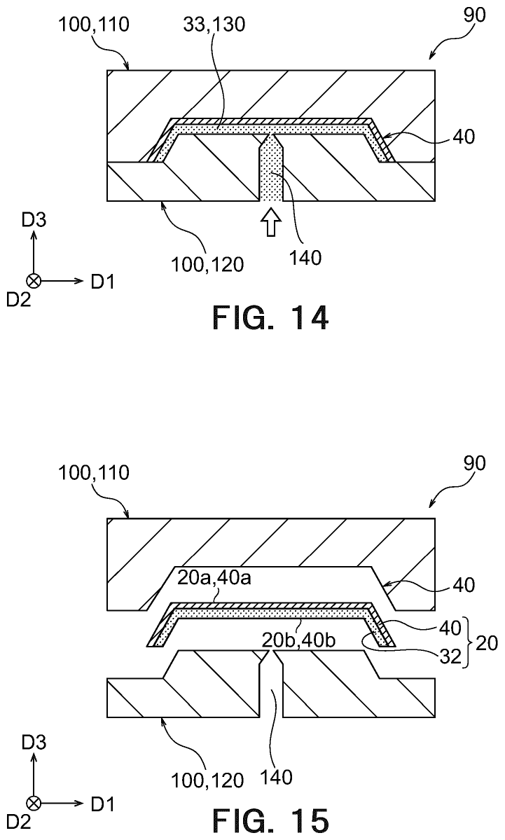

As illustrated in FIGS. 12 and 15, the mold 100 can assume an open state where the first mold 110 and the second mold 120 are separated from each other. As illustrated in FIGS. 13 and 14, the mold 100 can assume a closed state where the first mold 110 and the second mold 120 are in contact with each other. The first mold 110 and the second mold 120 can be moved relative to each other so as to come close to each other from the open state to the closed state. The first mold 110 and the second mold 120 can be moved relative to each other so as to come apart from each other from the closed state to the open state.

As illustrated in FIG. 14, when the mold 100 is in a closed state, a cavity 130 is formed between the first mold 110 and the second mold 120. The mold 100 has a gate 140 that leads to the cavity 130. In the illustrated example, the gate 140 is formed in the second mold 120. The gate 140 connects to a feeder apparatus of the injection resin 33 not illustrated in the drawings. The injection resin 33 is fed to the cavity 130 through the gate 140.

As illustrated in FIG. 12, the decorative surface material 40 is conveyed into the mold 100. The decorative surface material 40 conveyed into the mold 100 is housed in the cavity 130 in the mold 100. In the illustrated example, the decorative surface material 40 is held on the first mold 110 with the first surface 40a contacting the first mold 110. In a state where the decorative surface material 40 is held on the first mold 110, the second surface 40b faces the second mold 120.

Next, as illustrated in FIG. 13, the mold 100 is brought into a closed state. In the mold 100 in the closed state, a cavity 130 is formed between the first mold 110 and the second mold 120. The decorative surface material 40 is housed in the cavity 130. In a state where the decorative surface material 40 is held in the mold 100, the second surface 40b faces the cavity 130.

Next, as illustrated in FIG. 14, the melted injection resin 33 is injected into the cavity 130 through the gate 140. The injection resin 33 is cooled in the cavity 130 and melt-bonds and solidifies onto the decorative surface material 40. The thermoplastic resin part 32 bonded to the decorative surface material 40 is formed from the solidified injection resin 33.

Next, as illustrated in FIG. 15, the mold 100 is brought into an open state. In the mold 100 in the open state, the first mold 110 and the second mold 120 come apart from each other. A decorative member 20 that includes the decorative surface material 40 and the thermoplastic resin part 32 bonded to the decorative surface material 40 is removed from the cavity 130. As such, a decorative member 20 that includes a decorative surface material 40 and a thermoplastic resin part 32 is obtained.

Furthermore, by stacking a light source 15 and the decorative member 20, a display system 10 illustrated in FIGS. 1 to 4 is obtained. Here, the thermoplastic resin part 32 is located between the light source 15 and the decorative surface material 40.

According to a known decorative member production method, the molding process has been performed on a decorative surface material in which a transmitting part has been formed. According to this production method, during the molding process of the decorative surface material, the position and shape of the transmitting part can greatly change with deformation of the decorative surface material. Meanwhile, it is difficult to determine the position and shape of the transmitting part before the molding process by considering the positional deviation and shape changes of the transmitting part associated with the molding process. Thus, it has been difficult to provide a transmitting part having a desired shape at a desired position in the known decorative surface material and decorative member. As a result, known decorative surface materials and decorative members are not always capable of displaying a desired pattern by the light that has passed through the transmitting part.

A method for producing the decorative member 20 according to this embodiment includes a step of subjecting a decorative sheet 35 that includes a light shielding layer 52 to a molding process, a step of preparing a decorative surface material 40 including recessed portions 45 from the decorative sheet 35 by removing some portions of the light shielding layer 52 from the decorative sheet 35, and a step of forming a thermoplastic resin part 32 bonded to the decorative surface material 40. According to this production method, the recessed portions 45 that form the transmitting part 41 of the decorative surface material 40 are formed after the molding process of the decorative sheet 35. As a result, it becomes possible to suppress deviation of the position of the transmitting part 41 and deformation of the transmitting part 41 caused by the molding process of the decorative sheet 35. Furthermore, since the shape is imparted to the decorative sheet 35 by the molding process, it becomes possible to accurately and easily determine the positions of the recessed portions 45 to be processed relative to the decorative sheet 35. Thus, the decorative member 20 obtained by this production method can present a display having a desired pattern by the light that has passed through the transmitting part.

The operation of the illustrated display system 10 will now be described.

When the light source 15 is in an off state, as illustrated in FIG. 2, the decorative member 20 covering the light source 15 is observed. The decorative member 20 displays the design of the decorative surface material 40. The design of the decorative surface material 40 is formed by the design layer 51. The design layer 51 straddles over the transmitting part 41 and the light shielding part 42 of the decorative surface material 40. In this manner, the decorative surface material 40 can display the design formed in the design layer 51 in both the transmitting part 41 and the light shielding part 42. In other words, the decorative member 20 can display the design even in the transmitting part 21 overlaying the light source 15. Furthermore, the light source 15 overlaying the transmitting part 21 of the decorative member 20 can be effectively hidden by the design layer 51 covering both the transmitting part 41 and the light shielding part 42.

When the light source 15 is in an on state, light is emitted from the light source 15 toward the decorative member 20. The light that has entered the decorative member 20 travels within the thermoplastic resin part 32 toward the decorative surface material 40. The light traveling toward the decorative surface material 40 enters the transmitting part 41 or the light shielding part 42. The light that has entered the light shielding part 42 passes through the bonding layer 63 and is absorbed by the light shielding layer 52. The light that has entered the transmitting part 41 passes through the thermoplastic resin part 32 located within the recessed portions 45 and reaches the base layer 61. The light that has reached the base layer 61 passes through the base layer 61, the design layer 51, and the surface layer 62 and released from the display surface 11 formed by the first surface 40a of the decorative surface material 40. As such, the light that has entered the decorative member 20 is released from the transmitting part 21 formed by the transmitting part 41 of the decorative surface material 40. Thus, when the light source 15 is in an on state, as illustrated in FIG. 3, the pattern of the transmitting part 21 is displayed. In the illustrated example, a cross, a triangle, and a square are displayed.

It should be noted that a known decorative surface material disclosed in JP 2017-65168 A includes a decorative part that includes a design layer and a non-decorative part not including a design layer. In a known decorative surface material, the decorative part displays a design. The non-decorative part can transmit light of the light source disposed at the rear surface of the decorative surface material. In the non-decorative part, the design layer is removed. The design layer is provided in only the decorative part. When the known decorative surface material is observed, even when the light source is off, the non-decorative part can be observed from the outside as a portion where the design layer is disrupted. The design properties of the decorative surface material can degrade if the non-decorative part is observed from the outside. Furthermore, with the known decorative surface material, the harmony and coherence with the ambient environment cannot be sufficiently secured for the application subjects of the decorative surface material.

The decorative surface material 40 according to the present embodiment includes a design layer 51 and a light shielding layer 52 in sequence from the first surface 40a toward the second surface 40b. The decorative surface material 40 includes recessed portions 45 that open to the second surface 40b. The recessed portions 45 extend through the light shielding layer 52 but do not extend through the design layer 51. When the light source 15 is disposed on the second surface 40b side of the decorative surface material 40, the decorative surface material 40 in the transmitting part 41 formed by the recessed portions 45 can transmit light from the light source 15. The design layer 51 is not disrupted by the transmitting part 41 formed by the recessed portions 45 and is provided to cover the transmitting part 41 as well. Thus, when the light source is turned off, the presence of the transmitting part 41 is rarely recognizable, and, furthermore, the design of the design layer 51 can be displayed also in the portion above the transmitting part 41 as with other parts. In this manner, the design properties of the decorative surface material 40 can be improved. As a result, the decorative member 20 including this decorative surface material 40 can securely obtain harmony and coherence with the ambient environment through design presentations of the improved decorative surface material 40.

In the example illustrated in FIGS. 1 to 4, the decorative surface material 40 includes a base layer 61 between the design layer 51 and the light shielding layer 52. The bottom portions 46 of the recessed portions 45 are formed by the base layer 61. According to this specific example, the design layer 51 and the light shielding layer 52 can be separated from each other in the stacking direction (in FIG. 4, the third direction D3) by the base layer 61. In this manner, when the light shielding layer 52 is removed by laser etching, marking-off, etc., unintended removal of the design layer 51 can be suppressed. For example, consider the case in which a laser beam is focused at the light shielding layer 52 in order to remove the light shielding layer 52. In this case, the temperature elevation in the design layer 51 by the laser beam can be reduced by bringing the design layer 51 away from the focus of the laser beam. Since the temperature elevation in the design layer 51 is reduced, removal of the design layer 51 can be suppressed. Thus, according to this specific example, the design properties of the decorative surface material 40 can be stably improved.

In the example illustrated in FIG. 4, the display system 10 includes the decorative member 20 and the light source 15 facing the decorative member 20. The decorative member 20 includes a decorative surface material 40 that includes a first surface 40a and the second surface 40b, and a thermoplastic resin part 32 bonded to the second surface 40b of the decorative surface material 40.

The thermoplastic resin part 32 is located between the decorative surface material 40 and the light source 15 in the third direction. The display surface 11 is formed by the first surface 40a of the decorative surface material 40. The decorative surface material 40 includes a light shielding layer 52. The decorative surface material 40 includes recessed portions 45 that open to the second surface 40b and extend through the light shielding layer 52. In this display system 10, of the light that has reached the decorative surface material 40, the light that has passed through the transmitting part 41 makes the pattern of the transmitting part 41 observable in the display surface 10a. Then the light emitted from the light source 15 passes through the thermoplastic resin part 32 and reaches the decorative surface material 40. In other words, the light that displays the display pattern by passing through the transmitting part 41 reaches the display surface 10a without passing through the thermoplastic resin part 32. The thermoplastic resin part 32 is a layer having a relatively large thickness, and the light can diffuse while travelling in the thermoplastic resin part 32. Accordingly, the light that has passed through the transmitting part 41 and forms the display pattern can reach the display surface 10a without prominent diffusion. As a result, the display system 10 can display the desired display pattern with a clear contour.

In the embodiment described above, the decorative surface material 40 has a first surface 40a and a second surface 40b opposite from the first surface 40a. The decorative surface material 40 includes a design layer 51 and a light shielding layer 52 in sequence from the first surface 40a toward the second surface 40b. The decorative surface material 40 includes recessed portions 45 that open to the second surface 40b. The recessed portions 45 extend through the light shielding layer 52 but do not extend through the design layer 51. According to this decorative surface material 40, the design layer 51 is provided to also cover the transmitting part 41 without being disrupted by the transmitting part 41 formed by the recessed portions 45. Thus, when the light source is turned off, the presence of the transmitting part 41 is rarely recognizable, and, furthermore, the design of the design layer 51 can be displayed also in the portion above the transmitting part 41 as with other parts. In this manner, the design properties of the decorative surface material 40 can be improved when observed from the first surface 40a side.

One embodiment has been described heretofore by referring to specific examples but the aforementioned specific examples do not limit the embodiment. The embodiment described above can be implemented through various other specific examples, and various omissions, replacements, alterations, additions, etc., are possible without departing from the gist thereof.

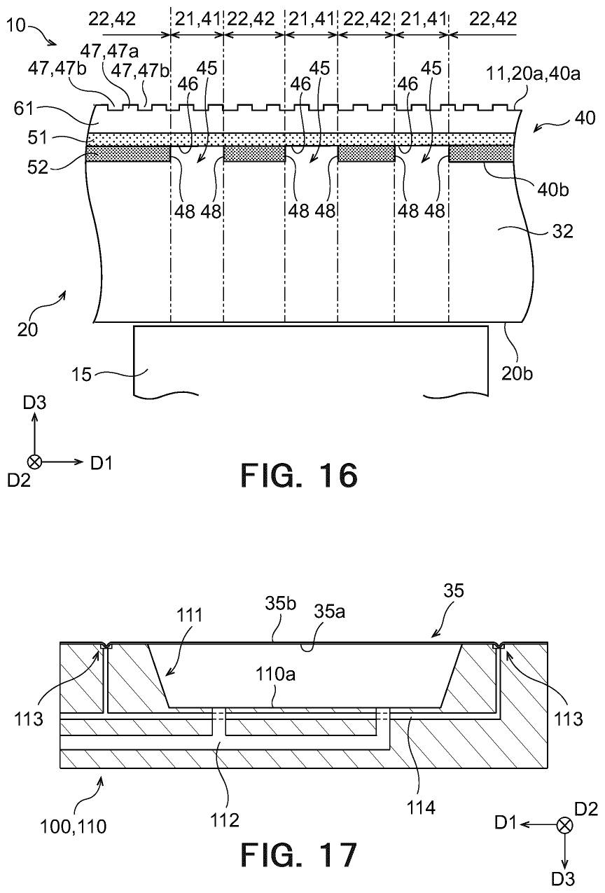

An example of a modification will now be described by mainly referring to FIGS. 16 to 23. Of these, FIG. 16 is a cross-sectional view illustrating one modification of the decorative member 20. FIGS. 17 to 23 are diagrams illustrating one example of a method for producing the decorative member 20 illustrated in FIG. 16. In the descriptions below and the drawings used in the descriptions below, the features that can be configured similarly to those in the aforementioned specific example are denoted by the same reference signs as those used for the corresponding features in the aforementioned specific examples, and the descriptions therefor are omitted to avoid redundancy.

In one specific example of the decorative surface material 40 described above, the base layer 61 is located between the design layer 51 and the light shielding layer 52. However, this is not limiting, and, as illustrated in FIG. 16, the base layer 61 may be located on the first surface 40a side with respect to the design layer 51. That is, the design layer 51 may be located between the base layer 61 and the light shielding layer 52. The decorative surface material 40 may include a base layer 61, a design layer 51, and a light shielding layer 52 in sequence from the first surface 40a toward the second surface 40b.

In one specific example of the decorative surface material 40 described above, the design layer 51 and the light shielding layer 52 are separated from each other in the stacking direction via the base layer 61. This is not limiting and, as illustrated in FIG. 16, the design layer 51 and the light shielding layer 52 may be adjacent to each other in the stacking direction.

In one specific example of the decorative surface material 40 described above, the bottom portions 46 of the recessed portions 45 are formed by the base layer 61. In the decorative surface material 40 described above, the recessed portions 45 are not formed in the design layer 51. In the recessed portions 45 described above, none of the bottom portions 46 and the wall portions 48 are formed by the design layer 51. However, the example described above is not limiting, and the bottom portions 46 of the recessed portions 45 may be formed by the design layer 51, as illustrated in FIG. 16. In the recessed portions 45 illustrated in FIG. 16, the wall portions 48 are not formed by the design layer 51.

In one specific example of the decorative surface material 40 described above, the first surface 40a of the decorative surface material 40 is flat. This is not limiting, and the decorative surface material 40 may have an uneven shape 47 on the first surface 40a. As illustrated in FIG. 16, an uneven surface may be formed on the first surface 40a by the uneven shape 47. In the illustrated example, the uneven shape 47 is formed on the base layer 61. Since the decorative surface material 40 has the uneven shape 47, the decorative member 20 also has an uneven shape 27 on the first surface 20a.

In the example illustrated in FIG. 16, the uneven shape 47 is constituted by raised parts 47a and depressed parts 47b. The raised parts 47a and depressed parts 47b may be alternately arranged in one direction. In the illustrated example, the raised parts 47a and depressed parts 47b are alternately arranged in the first direction D1 as the arrangement direction.

In the example illustrated in FIG. 16, the difference in height between the raised parts 47a and the depressed parts 47b may be smaller than the average thickness of the base layer 61 on which the uneven shape 47 is formed. Here, in order to specify the “average thickness of the base layer”, a decorative surface material 40 that has a length of 50 μm in a direction (for example, the first direction D1 in FIG. 16) orthogonal to the stacking direction (in FIG. 16, the third direction D3) is used. The “average thickness of the base layer” is calculated as the average of lengths of the base layer 61 in the stacking direction of the decorative surface material 40 measured at arbitrarily selected 20 sites in a cross section of the decorative surface material 40. The “difference in height between the raised parts and the depressed parts” is calculated as the difference between the fifth largest thickness and the fifth smallest thickness among the thicknesses of the base layer 61 measured at the aforementioned arbitrarily selected 20 sites. The difference in height between the raised parts 47a and the depressed parts 47b may be 5 μm or more and 30 μm or less.

A pattern may be presented in the first surface 40a of the decorative surface material 40 by the uneven shape 47. A linear pattern such as a hairline pattern or a spin pattern may be presented by the uneven shape 47. According to this specific example, the texture of the decorative surface material 40 observed from the first surface 40a can be changed. In this manner, the design properties of the decorative surface material 40 can be improved.

The decorative surface material 40 illustrated in FIG. 16 may be prepared from a decorative sheet 35 that has, on a first surface 35a, an uneven shape that will eventually form the uneven shape 47 of the decorative surface material 40. The decorative sheet 35 may be irradiated with a laser from the second surface 35b side opposite from the first surface 35a having an uneven shape. When the laser irradiation is performed from the second surface 35b side, scattering of the laser beam at the surface of the decorative sheet 35 can be reduced compared to when the laser irradiation is performed from the first surface 35a side. In this manner, the focus position of the laser beam irradiating the decorative sheet 35 can be easily adjusted, and the light shielding layer 52 can be removed at the desired positions. Thus, when the decorative surface material 40 is prepared as such, the recessed portions 45 can be stably formed on the decorative surface material 40 irrespective of the uneven shape 47 on the first surface 40a.

The decorative member production method described above is merely one example. The decorative member may be produced by other production methods. Hereinafter, other examples of the production method are described. In the production method described below, as one example, the decorative member 20 illustrated in FIG. 16 is produced. In this production method, the decorative sheet 35 is subjected to a molding process using a first mold 110. A decorative surface material 40 is prepared by forming recessed portions 45 in a decorative sheet 35 placed on the first mold 110. In addition, while the decorative surface material 40 is placed on the first mold 110, a second mold is stacked on the first mold 110. A thermoplastic resin part 32 bonded to the decorative surface material 40 is formed by injecting a thermoplastic resin into a cavity 130 formed between the first mold 110 and the second mold. The details thereof will now be described.

A decorative sheet 35 is prepared. A design layer 51 and a light shielding layer 52 are stacked on one surface of a base layer 61. The decorative sheet 35 is prepared such that the design layer 51 is located between the light shielding layer 52 and the base layer 61. The prepared decorative sheet 35 includes a base layer 61, a design layer 51, and a light shielding layer 52 in sequence from a first surface 35a toward a second surface 35b. The first surface 35a of the decorative sheet 35 is constituted by the base layer 61. The second surface 35b of the decorative sheet 35 is constituted by the light shielding layer 52.

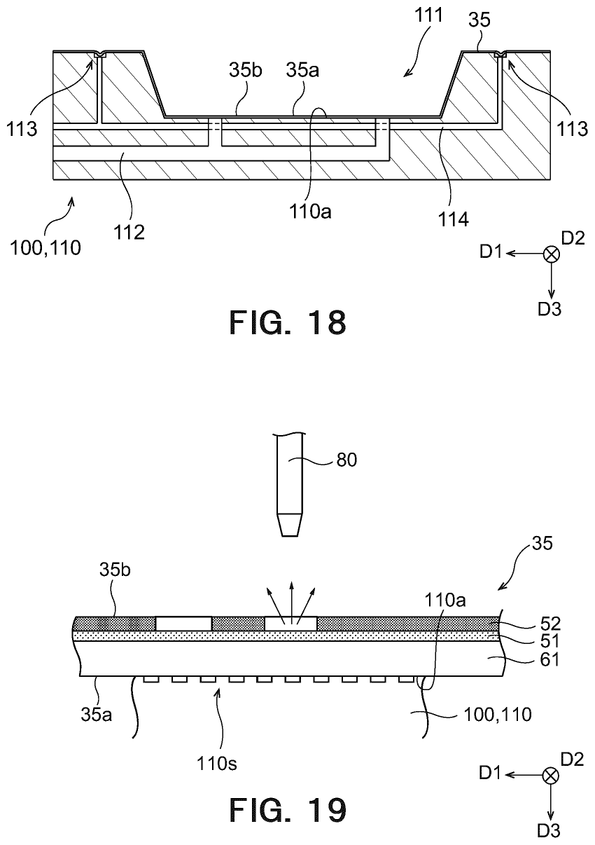

Next, the decorative sheet 35 is subjected to a molding process. The injection molding apparatus 90 is used in the molding process of the decorative sheet 35. In the example illustrated in FIGS. 17 and 18, the decorative sheet 35 is molded by using the first mold 110 of the mold 100 in an open state. The first mold 110 has a contact surface 110a that faces the decorative sheet 35. As described below with reference to FIGS. 17 and 18, the decorative sheet 35 may be molded by vacuum molding.

In the example illustrated in FIGS. 17 and 18, the first mold 110 has a molding recess 111 at the center portion in the first direction D1.

In the example illustrated in FIGS. 17 and 18, multiple first suction holes 112 are provided to the molding recess 111. The multiple first suction holes 112 open to the contact surface 110a of the first mold 110. The first suction holes 112 are connected to a suction pump not illustrated in the drawings. The suction pump suctions air inside the first suction holes 112.

In the example illustrated in FIGS. 17 and 18, the first mold 110 has a groove 113 on the outer side of the molding recess 111. In other words, compared to the molding recess 111, the groove 113 is at a position far from the center of gravity of the first mold 110.

In the example illustrated in FIGS. 17 and 18, multiple second suction holes 114 are provided to the groove 113. The second suction holes 114 are connected to a suction pump not illustrated in the drawings. The suction pump suctions air inside the second suction holes 114. Here, as the pump that suctions air inside the second suction holes 114, a pump different from the pump that suctions air inside the first suction holes 112 may be used.

In the example illustrated in FIG. 19, an uneven shape 110s corresponding to the uneven shape 47 of the decorative surface material 40 is formed on the contact surface 110a. The uneven shape 110s may be formed by various methods such as sand blasting.

As illustrated in FIG. 17, a decorative sheet 35 is supplied to the first mold 110 having the aforementioned features. In the illustrated example, the decorative sheet 35 in portions other than the molding recess 111 is in contact with the first mold 110. The decorative sheet 35 contacts the contact surface 110a of the first mold 110 from the first surface 35a. The opening of the groove 113 is closed by the decorative sheet 35.

Next, the air inside the second suction holes 114 is suctioned by a suction pump not illustrated in the drawing. The second suction holes 114 are in communication with the groove 113. The opening of the groove 113 is closed by the decorative sheet 35. As a result, the decorative sheet 35 is suctioned onto the groove 113. Consequently, in the state illustrated in FIG. 17, the decorative sheet 35 is held on the contact surface 110a of the first mold 110. In this state, the gap between the decorative sheet 35 and the first mold 110 is closed. In this state, the decorative sheet 35 may be depressed toward the inside of the groove 113.

Subsequently, the decorative sheet 35 suctioned by the second suction holes 114 is further suctioned by the first suction holes 112. The suction pump connected to the first suction holes 112 suctions the air inside the first suction holes 112 and the air between the molding recess 111 and the decorative sheet 35. In this manner, the portion of the decorative sheet 35 facing the molding recess 111 is suctioned toward the contact surface 110a forming the molding recess 111 as illustrated in FIG. 18. At the first surface 35a, the decorative sheet 35 can contact the contact surface 110a that forms the molding recess 111.

As described above, the decorative sheet 35 is molded by using the first mold 110. Note that, in the state illustrated in FIG. 18, the uneven shape 110s formed on the contact surface 110a may be transferred onto the first surface 35a of the decorative sheet 35. Alternatively, as illustrated in FIG. 19, the uneven shape 110s formed on the contact surface 110a does not have to be transferred onto the first surface 35a of the decorative sheet 35.

Next, a decorative surface material 40 is prepared from the decorative sheet 35 placed on the first mold 110. Specifically, as illustrated in FIG. 19, in the decorative sheet 35 held on the first mold 110, some portions of the light shielding layer 52 are removed from the second surface 35b side. As illustrated in FIG. 19, the light shielding layer 52 may be removed by laser etching.

In the example illustrated in FIG. 19, the laser beam emitted from the laser irradiation apparatus 80 irradiates the decorative sheet 35. The laser beam enters the decorative sheet 35 from the second surface 35b side. The laser beam that has entered the decorative sheet 35 from the second surface 35b side removes some portions of the light shielding layer 52. The design layer 51 is exposed from the portions where the light shielding layer 52 has been removed. The focus position of the laser beam may be adjusted according to the distance from the laser irradiation apparatus 80 to the light shielding layer 52 such that some portions of the light shielding layer 52 are removed. By removing some portions of the light shielding layer 52, as illustrated in FIG. 19, openings are formed in the second surface 35b of the decorative sheet 35.

During the process of forming the recessed portions 45, the decorative sheet 35 is held on the first mold 110. Thus, the processing machine used to form the recessed portions 45, that is, the laser irradiation apparatus 80 in the illustrated example, operates by using the first mold 110 as a reference, and thus is highly accurately positioned relative to the decorative sheet 35. Thus, the recessed portions 45 having desired shapes can be highly accurately formed at the desired positions of the decorative sheet 35 that has a shape imparted by molding.

As described above, a decorative surface material 40 including recessed portions 45 is prepared from the decorative sheet 35 placed on the first mold 110. The prepared decorative surface material 40 includes recessed portions 45 that open to the second surface 40b.

Next, a thermoplastic resin part 32 bonded to the decorative surface material 40 is formed.

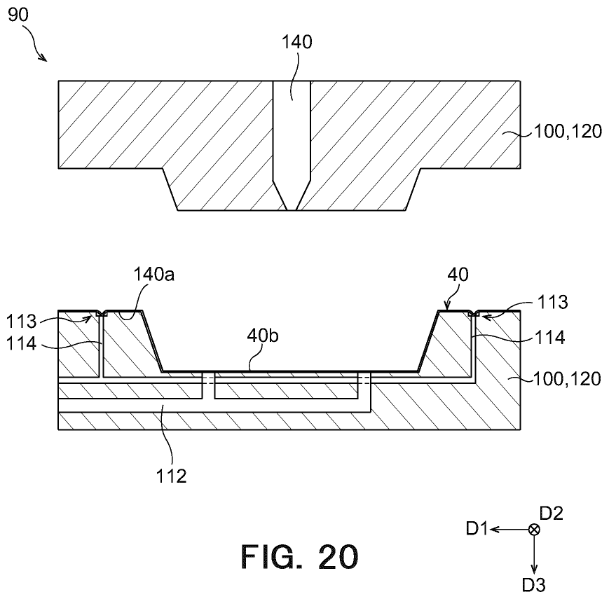

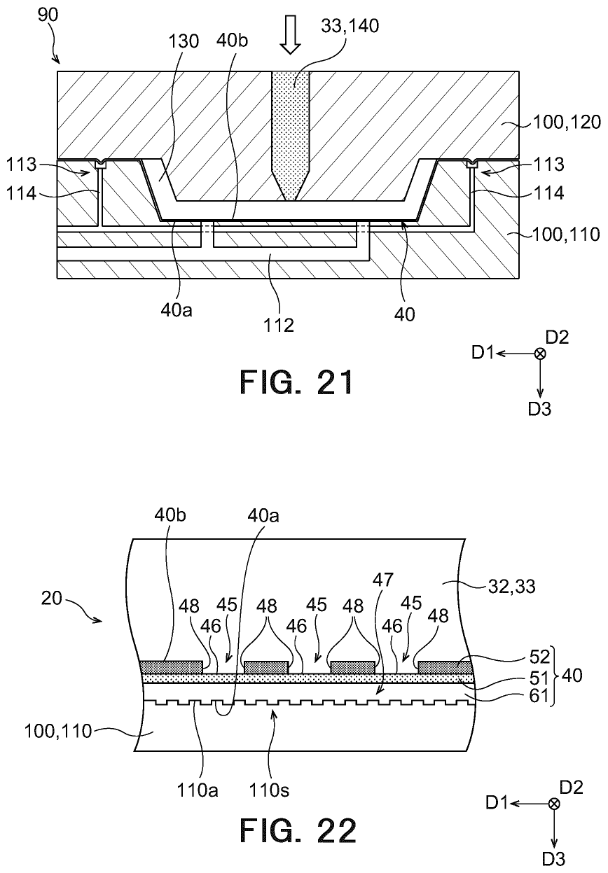

First, from the state illustrated in FIG. 20, the second mold 120 is stacked on the first mold 110. When the second mold 120 is brought close to the first mold 110 from the state illustrated in FIG. 20, the second mold 120 and the first mold 110 overlay as illustrated in FIG. 21. In other words, the mold 100 assumes a closed state. In the closed state, a cavity 130 is formed between the first mold 110 and the second mold 120. In the closed state, the decorative surface material 40 is housed inside the cavity 130. In the state illustrated in FIG. 21, the first surface 40a of the decorative surface material 40 faces the first mold 110. The second surface 40b of the decorative surface material 40 faces the second mold 120.

Next, as illustrated in FIG. 21, the injection resin 33 is injected into the cavity 130 through the gate 140. Next, the injection resin 33 is cooled in the cavity 130 and melt-bonds and solidifies onto the decorative surface material 40. The thermoplastic resin part 32 bonded to the decorative surface material 40 is formed from the solidified injection resin 33.

In the illustrated example, the decorative surface material 40 is pressed against the first mold 110 by the injection resin 33 injected into the cavity 130. The first surface 40a formed by the base layer 61 of the decorative surface material 40 pressed against the first mold 110 is strongly pressed against the contact surface 110a of the first mold 110. As a result, the uneven shape 110s formed on the contact surface 110a is transferred onto the first surface 40a of the decorative surface material 40.

According to this specific example, a decorative surface material 40 having an uneven shape 47 on the first surface 40a can be efficiently prepared.

After the decorative sheet thermoplastic resin part 32 is formed, suction of the decorative surface material 40 from the first suction holes 112 and the suction of the decorative surface material 40 from the second suction holes 114 in the first mold 110 are stopped. As a result, the movement of the decorative surface material 40 relative to the first mold 110 becomes unregulated.

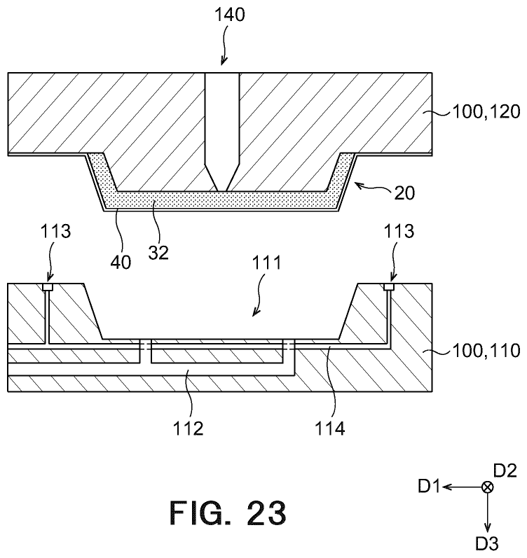

Next, as illustrated in FIG. 23, the first mold 110 and the second mold 120 are separated from each other. In other words, the mold 100 assumes an open state. In a state where the decorative member 20 is held on the second mold 120, the decorative member 20 is separated from the second mold 120.

As described above, a decorative member 20 that includes a decorative surface material 40 and a thermoplastic resin part 32 bonded to the decorative surface material 40 is prepared. In the prepared decorative member 20, as described above with reference to FIG. 10, unneeded portions may be trimmed.

In the decorative member production method described above with reference to FIGS. 17 to 21, the decorative sheet 35 is molded by using the first mold 110. The decorative surface material 40 is prepared from the decorative sheet 35 placed on the first mold 110. In a state where the decorative surface material 40 is placed on the first mold 110, a second mold 120 is stacked on the first mold 110. A thermoplastic resin part 32 bonded to the decorative surface material 40 is formed by injecting a thermoplastic resin into a cavity 130 formed between the first mold 110 and the second mold 120.

According to this specific example, formation of the recessed portions 45 and injection molding are performed while the decorative sheet 35 molded by using the first mold 110 or the decorative surface material 40 remains placed on the first mold 110. Thus, formation of the recessed portions 45 and injection molding can be highly accurately performed while significantly simplifying positioning of the processed position relative to the decorative sheet 35 or decorative surface material 40 having an imparted shape. Thus, according to this example, the decorative member 20 can be prepared stably and highly accurately.

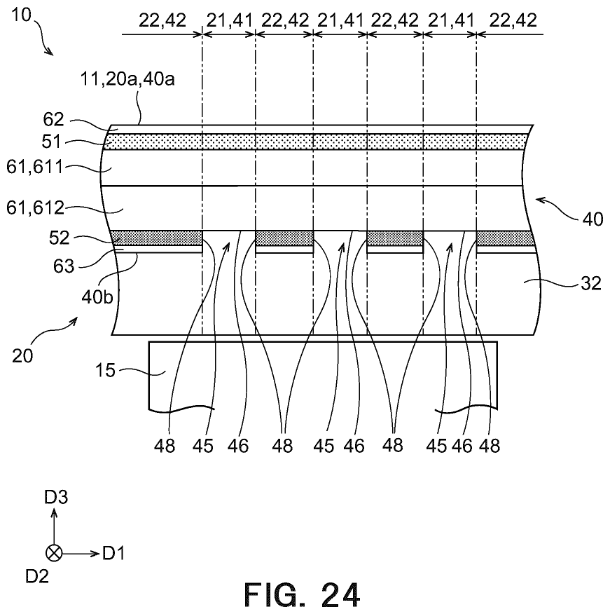

In the specific example of the decorative surface material 40 described above, the base layer 61 is a single layer. This is not limiting, and, as illustrated in FIG. 24, the base layer 61 may include a first base layer 611 and a second base layer 612. In the illustrated example, the first base layer 611 bonds to the second base layer 612 at a surface opposite from the surface supporting the surface layer 62 and the design layer 51. The second base layer 612 is bonded to the first base layer 611 at a surface opposite from the surface supporting the light shielding layer 52.

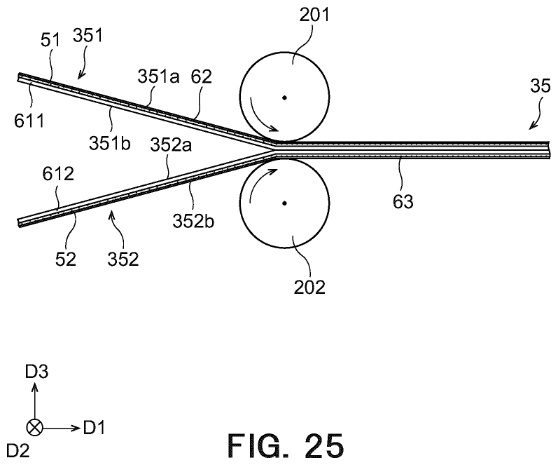

The first base layer 611 and the second base layer 612 may be bonded by thermal lamination as described below with reference to FIG. 25. In the illustrated example, a first decorative sheet 351 and a second decorative sheet 352 are conveyed between a first roll 201 and a second roll 202. The first decorative sheet 351 includes a surface layer 62, a design layer 51, and a first base layer 611 in sequence from a first surface 351a toward a second surface 351b. The second decorative sheet 352 includes a second base layer 612, a light shielding layer 52, and a bonding layer 63 in sequence from a first surface 352a toward a second surface 352b. One of the first roll 201 and the second roll 202 is heated by, for example, a built-in heating apparatus not illustrated in the drawing. Both the first roll 201 and the second roll 202 may be heated by a heating apparatus not illustrated in the drawing.

In the example illustrated in FIG. 25, the first decorative sheet 351 and the second decorative sheet 352 are pushed toward each other by the first roll 201 and the second roll 202. The first decorative sheet 351 melt-bonds with the first surface 352b of the second decorative sheet 352 from the second surface 351b. The second decorative sheet 352 melt-bonds with the second surface 351b of the first decorative sheet 351 from the first surface 352a. As described above, a decorative sheet 35 that includes a first base layer 611 and a second base layer 612 is prepared. Here, the first base layer 611 and the second base layer 612 may be bonded by, for example, dry lamination, and the aforementioned thermal lamination is not limiting.

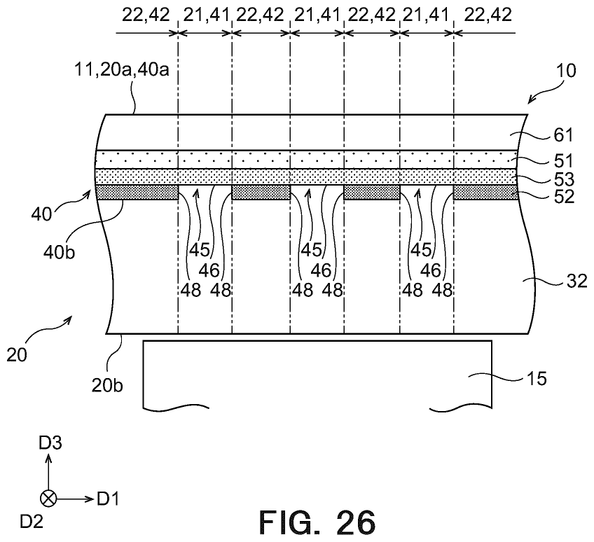

A decorative surface material 40 in which the base layer 61 is located on the first surface 40a side with respect to the design layer 51 is not limited to the example illustrated in FIG. 16. As illustrated in FIG. 26, the decorative surface material 40 may include a base layer 61, a design layer 51, an intermediate layer 53, and a light shielding layer 52 in sequence from the first surface 40a toward the second surface 40b. The decorative surface material 40 may include the intermediate layer 53 located between the design layer 51 and the light shielding layer 52. In the illustrated decorative surface material 40, the laser beam absorption of the intermediate layer 53 may be lower than the laser beam absorption of the light shielding layer 52. The laser beam absorption of the intermediate layer 53 may be 3% or less or 1% or less.

The decorative surface material 40 illustrated in FIG. 26 is prepared from the decorative sheet 35. In the decorative sheet 35, the design layer 51 is located between the base layer 61 and the light shielding layer 52. In the decorative sheet 35, the intermediate layer 53 is located between the design layer 51 and the light shielding layer 52. The illustrated recessed portions 45 are formed by removed portions of the light shielding layer 52. The illustrated recessed portions 45 do not extend through the intermediate layer 53. The illustrated recessed portions 45 do not extend through the design layer 51. Some portions of the light shielding layer 52 are removed by using laser irradiation from the second surface 35b side of the decorative sheet 35. Unlike the illustrated decorative surface material 40, the laser irradiation may remove some portions of the intermediate layer 53. The recessed portions 45 may be formed by portions where the light shielding layer 52 and the intermediate layer 53 have been removed.

Since the intermediate layer 53 is located between the design layer 51 and the light shielding layer 52, the design layer 51 and the light shielding layer 52 can be separated from each other in the first direction D1. Unintended removal of the design layer 51 by laser beam irradiation from the second surface 35b side of the decorative sheet 35 can be reduced. Thus, the decorative surface material 40 including the intermediate layer 53 can stably display the design formed by the design layer 51.

The intermediate layer 53 may be formed by printing. The thickness of the intermediate layer 53 may be 1 μm or more or 3 μm or more. The thickness of the intermediate layer 53 may be 30 μm or less or 20 μm or less.

The intermediate layer 53 may contain a resin. The intermediate layer 53 may contain a thermoplastic resin. The thermoplastic resin may contain at least one selected from an acrylic resin, a polyester resin, and a vinyl chloride vinyl acetate copolymer resin.

### REFERENCE SIGNS LIST

10: display system, 15: light source, 20: decorative member, 32: thermoplastic resin part, 33: injection resin, 35: decorative sheet, 35a: first surface, 35b: second surface, 40: decorative surface material, 40a: first surface, 40b: second surface, 45: recessed portion, 46: bottom portion, 47: uneven shape, 51: design layer, 52: light shielding layer, 61: base layer, 100: mold, 110: first mold, 110s: uneven shape, 120: second mold, 130: cavity, 140: gate

1. A decorative surface material having a first surface and a second surface opposite from the first surface, the decorative surface material comprising:
in sequence from the first surface toward the second surface, a design layer and a light shielding layer,
wherein the decorative surface material has a recessed portion that opens to the second surface, and
the recessed portion extends through the light shielding layer but does not extend through the design layer.

2. The decorative surface material according to claim 1, wherein the recessed portion includes a bottom portion and a wall portion that connects the bottom portion and the second surface, and
the wall portion is not formed by the design layer.

3. The decorative surface material according to claim 1, wherein the recessed portion is not formed in the design layer.

4. The decorative surface material according to claim 1, wherein the recessed portion is formed by a portion where the light shielding layer has been removed by using laser irradiation from the second surface side.

5. The decorative surface material according to claim 4, further comprising a base layer disposed between the design layer and the light shielding layer,
wherein the bottom portion of the recessed portion is formed by the base layer.

6. The decorative surface material according to claim 1, wherein the first surface has an uneven shape.

7. A decorative member comprising:
the decorative surface material according to claim 1; and
a thermoplastic resin part bonded to the second surface of the decorative surface material.

8. A display system comprising:
a light source; and
the decorative member according to claim 7 overlaying the light source,
wherein the thermoplastic resin part is located between the light source and the decorative surface material.

9. A decorative surface material production method comprising:
a step of removing, from a decorative sheet that includes a design layer and a light shielding layer in sequence from a first surface toward a second surface, a portion of the light shielding layer from the second surface side to form a recessed portion,
wherein the recessed portion extends through the light shielding layer but does not extend through the design layer.

10. The decorative surface material production method according to claim 9, wherein the recessed portion includes a bottom portion and a wall portion that connects the bottom portion and the second surface, and
the wall portion is not formed by the design layer.

11. The decorative surface material production method according to claim 9, wherein the recessed portion is not formed in the design layer.

12. The decorative surface material production method according to claim 9, wherein the recessed portion is formed in the decorative sheet that has been subjected to a molding process.

13. A decorative member production method comprising, in sequence:
a step of molding a decorative sheet that includes a design layer and a light shielding layer in sequence from a first surface toward a second surface;
a step of preparing a decorative surface material having a recessed portion from the decorative sheet by removing a portion of the light shielding layer from the second surface side of the decorative sheet; and
a step of forming a thermoplastic resin part bonded to the decorative surface material,
wherein the recessed portion extends through the light shielding layer but does not extend through the design layer.

14. The decorative member production method according to claim 13, wherein the recessed portion includes a bottom portion and a wall portion that connects the bottom portion and the second surface, and
the wall portion is not formed by the design layer.

15. The decorative member production method according to claim 13, wherein the recessed portion is not formed in the design layer.

16. The decorative member production method according to claim 13, wherein the portion of the light shielding layer is removed by laser irradiation from the second surface side.

17. The decorative member production method according to claim 13, wherein the thermoplastic resin part bonded to the decorative surface material is formed by conveying the decorative surface material into a mold that includes a first mold and a second mold and, while the decorative surface material is housed in the mold, injecting a thermoplastic resin into a cavity formed between the first mold and the second mold.

18. The decorative member production method according to claim 13, wherein
the decorative sheet is molded by using a first mold,
the decorative surface material is prepared by forming a recessed portion in the decorative sheet placed on the first mold, and
the thermoplastic resin part bonded to the decorative surface material is formed by, while the decorative surface material is placed on the first mold, stacking the second mold on the first mold and injecting a thermoplastic resin into a cavity formed between the first mold and the second mold.

19. The decorative member production method according to claim 17, wherein the first mold has an uneven shape in a portion that faces the decorative surface material placed on the first mold, and
the decorative surface material is pressed against the uneven shape of the first mold by the thermoplastic resin injected from the cavity.
